(19) United States
(12) Patent Application Publication
(10) Pub. No.: US 2019/0332948 A1
(43) Pub. Date: Oct. 31, 2019

(54) SITUATION-AWARE COGNITIVE ENTITY

(71) Applicant: INTERNATIONAL BUSINESS MACHINES CORPORATION, ARMONK, NY (US)

(72) Inventors: Amol Dhondse, Kothrud (IN); Bruce A. Jones, Highland, NY (US); Dale K. Davis Jones, Ocala, FL (US); Debojyoti Mookerjee, Wahroonga (AU); Anand Pikle, Pune (IN); Gandhi Sivakumar, Bentleigh (AU)

(21) Appl. No.: 15/963,551

(22) Filed: Apr. 26, 2018

(51) Int. Cl. G06N 5/02; G06F 17/30; G06N 99/00

(52) U.S. Cl. CPC G06N 5/022; G06N 99/005; G06F 17/3043

(57) ABSTRACT

An approach is provided for generating a response by a cognitive entity. A question input by a user to the cognitive entity is received. A context of the user is determined. Based on the context of the user, an amount of detail for the response to the question is selected from different amounts of detail. The response is generated and presented to the user so that the response has the selected amount of detail.

### BACKGROUND

The present invention relates to a cognitive entity utilizing an elastic cognitive model, and more particularly to a question answering (QA) system generating responses based on user context.

A cognitive entity (e.g., virtual assistant or chatbot) is a hardware and/or software-based system that interacts with human users, remembers prior interactions with users, and continuously learns and refines responses for future interactions with users. Natural language processing (NLP) facilitates the interactions between the CE and the users. In one embodiment, the CE is a QA system that answers questions about a subject based on information available about the subject's domain, where the questions are presented in a natural language. The QA system has access to a collection of domain-specific information which may be organized in a variety of configurations such as ontologies, unstructured data, or a collection of natural language documents about the domain.

### SUMMARY

In one embodiment, the present invention provides a method of generating a response by a cognitive entity. The method includes a computer receiving a question input by a user to the cognitive entity. The method further includes the computer determining a context of the user. The method further includes based on the context of the user, the computer selecting an amount of detail for the response to the question. The amount of detail is selected from different amounts of detail. The method further includes the computer generating and presenting the response to the user so that the response has the selected amount of detail.

In another embodiment, the present invention provides a computer program product for generating a response by a cognitive entity. The computer program product includes a computer readable storage medium having program instructions stored on the computer readable storage medium. The computer readable storage medium is not a transitory signal per se. The program instructions are executed by a central processing unit (CPU) of a computer system to implement a method. The method includes a computer system receiving a question input by a user to the cognitive entity. The method further includes the computer system determining a context of the user. The method further includes based on the context of the user, the computer system selecting an amount of detail for the response to the question. The amount of detail is selected from different amounts of detail. The method further includes the computer system generating and presenting the response to the user so that the response has the selected amount of detail.

In another embodiment, the present invention provides a computer system including a central processing unit (CPU); a memory coupled to the CPU; and a computer readable storage medium coupled to the CPU. The computer readable storage medium contains instructions that are executed by the CPU via the memory to implement a method of generating a response by a cognitive entity. The method includes a computer system receiving a question input by a user to the cognitive entity. The method further includes the computer system determining a context of the user. The method further includes based on the context of the user, the computer system selecting an amount of detail for the response to the question. The amount of detail is selected from different amounts of detail. The method further includes the computer system generating and presenting the response to the user so that the response has the selected amount of detail.

Embodiments of the present invention provide a QA system or another cognitive entity that generates a response to a user's question at a level of detail that is appropriate to the urgency or other attributes of the situation of the user, thereby increasing user satisfaction by allowing the interaction between the user and the QA system or other cognitive entity to closely resemble human-to-human interaction.

### BRIEF DESCRIPTION OF THE DRAWINGS

FIG. 1 is a block diagram of a system for generating a response by a cognitive entity using an elastic cognitive model, in accordance with embodiments of the present invention.

FIG. 2 is a flowchart of a process of generating a response by a cognitive entity using an elastic cognitive model, where the process is implemented by the system of FIG. 1, in accordance with embodiments of the present invention.

FIG. 3 is a block diagram of puffer and deflator engine pipelines used in the process of FIG. 2, in accordance with embodiments of the present invention.

FIG. 4A is an example of a response resulting from the process of FIG. 2 and using an elongated puffer concatenated annotator and a brief puffer concatenated annotator, in accordance with embodiments of the present invention.

FIG. 4B is an example of a response resulting from the process of FIG. 2 and using an elongated puffer inline annotator and a brief puffer inline annotator, in accordance with embodiments of the present invention.

FIG. 4C is an example of a response that is deflated by the process of FIG. 2, which uses a deflator inline annotator, in accordance with embodiments of the present invention.

FIG. 4D is an example of a response that is deflated by the process of FIG. 2, which uses a deflator cherry pick annotator, in accordance with embodiments of the present invention.

FIG. 5 is a block diagram of a computer that is included in the system of FIG. 1 and that implements the process of FIG. 2, in accordance with embodiments of the present invention.

### DETAILED DESCRIPTION

### Overview

Embodiments of the present invention provide an enhanced cognitive entity (CE) that generates and presents elastic responses to a user, where a response is an expanded (i.e., puffed up) or deflated (i.e., shrunken) form of a base response, depending on the contextual situation of the user. The elastic responses allow the enhanced CE to interact with the user in a manner that aligns with human behavior (i.e., behavior that the user would expect if the interaction had been between the user and a human). The enhanced CE may interact with a user to provide an amount of detail in a response that matches a level of urgency or other attributes of the context of the user. At run time and depending on a situational trigger, a puffer annotator expands a base corpus or a deflator annotator shrinks the base corpus to generate a situation-aware response.

### System for Generating a Response Using an Elastic Cognitive Model

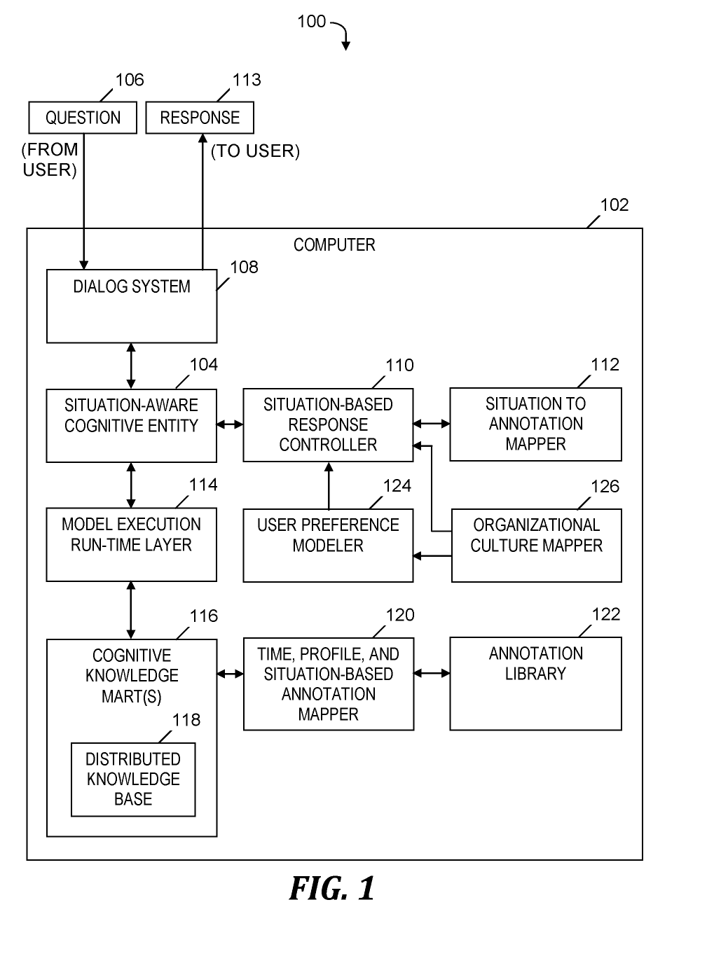

FIG. 1 is a block diagram of a system 100 for generating a response by a cognitive entity using an elastic cognitive model, in accordance with embodiments of the present invention. System 100 includes a computer 102 which executes a software-based situation-aware cognitive entity 104. In embodiments of the present invention, situation-aware cognitive entity 104 is a component of a QA system (not shown) or includes a QA system.

Situation-aware cognitive entity 104 receives a question 106 from a user via a dialog system 108, which may include a natural language/event interpreter and machine translator that receive question 106 as a voice input in a natural language of the user, and perform a voice to text translation and/or capture key entities from the voice input.

Situation-aware cognitive entity 104 determines contextual parameters of the user that specifies a situation and a status of the user, which may include the current activities of the user, the current health condition of the user, and an indication of whether the user is in an emergency situation (e.g., an accident, fire, or severe weather event), where a level of urgency exceeds a predefined threshold level of urgency. In one embodiment, the status of the user includes the social position of the user (i.e., position of the user in society). The social position of the user may be determined or influenced by the culture of the user and may be based on factors such as the user's age, wealth, and social status. In one embodiment, the status of the user includes a role of the user in an organization (e.g., the user is an executive in a corporation). The situation and status of the user is also referred to herein collectively as the context of the user. In one embodiment, the contextual parameters specify the context of the user along with the current time and profile information of the user (e.g., the role of the user in an organization).

In one embodiment, situation-aware cognitive entity 104 is in communication with one or more devices (not shown) via a computer network (not shown) and receives contextual parameters from the one or more devices. As one example, situation-aware cognitive entity 104 receives contextual parameters from a wearable computer that the user is wearing and that provides information about current activities of the user.

Situation-aware cognitive entity 104 sends the contextual parameters to a situation-based response controller 110, which sends the contextual parameters to a situation to annotation mapper 112. Based on the context of the user specified by the contextual parameters, situation to annotation mapper 112 determines whether to puff up (i.e., enhance with additional details) or deflate (i.e., make more brief by deleting details) a base response to question 106. Situation to annotation mapper 112 further determines the kind of puffing up (i.e., add phrases or sentences inline or concatenate sentences to the end of the base response) or deflating (i.e., delete phrases or sentences inline or cherry pick to select one or more words and/or phrases that make up the entirety of the response) that is performed on the base response. Situation to annotation mapper 112 sends its determination of puffing up or deflating and the kind of puffing up or deflating to situation-based response controller 110, which in response, constructs a response 113 to question 106.

In one embodiment, situation-aware cognitive entity 104 receives contextual parameters from a tone analyzer (not shown) that determines the tone of the voice of the user. Based on the tone, situation-aware cognitive entity 104 determines the mood of the user or determines whether the user is conveying a level of urgency that exceeds a predetermined threshold level, where the urgency may be caused by the user being in an emergency situation or having limited time to receive and process a response to question 106. Based on the tone indicating a level of urgency that exceeds the threshold level, situation-based response controller 110 may override one or more other contextual parameters to generate response 113 using deflators because the user is in an emergency situation or otherwise needs a brief response to question 106.

In response to receiving question 106 and via a model execution run-time layer 114, situation-aware cognitive entity 104 communicates with cognitive knowledge mart(s) 116 to retrieve from a distributed knowledge base 118 a base response to question 106. Situation-aware cognitive entity 104 retrieves the aforementioned base response together with annotations that are mapped to a time, a profile of the user, and a situation of the user by a time, profile, and situation-based annotation mapper 120 and are stored in an annotation library 122. Situation-aware cognitive entity 104 retrieves the base response and its annotations so that the time, profile and situation mapped to the annotations match the contextual parameters that specify the user context, and the annotations indicate the puffed up or deflated version of the base response that that is generated by situation-based response controller 110 and sent by situation-aware cognitive entity 104 as response 113 via dialog system 108. As one example, dialog system 108 may include a visualization and voice renderer (not shown) and a visual response and voice mapper (not shown) to present response 113 as to the user as a voice output or as textual output in the natural language of the user or as other visual information.

In one embodiment, situation-based response controller 110 receives preferences of the user or organization-level preferences from a user preference modeler 124. Situation-based response controller 110 uses the received preferences as a basis for selecting a puffing up or a deflation of a base response to question 106 to generate response 113. The effect of preferences that indicate a puffed up response may be overridden by a tone analyzer (not shown) that determines that the voice of the user has an urgent tone, thereby indicating that the user is in an emergency situation or otherwise needs a brief response to question 106.

In one embodiment, situation-based response controller 110 receives information about the culture of the user from an organizational culture mapper 126, where the culture is the basis of user preferences determined by user preference modeler 124. Situation-based response controller 110 uses the received information about the culture of the user as a basis for puffing up or deflating a base response to generate response 113.

A model-driven scores component (not shown), which may be included in cognitive knowledge mart(s) 116 or in another component of system 100, determines a confidence score that indicates a level of confidence that the response 113 is appropriate based on the context of the user. In one embodiment, situation-aware cognitive entity 104 presents response 113 to the user if the model-driven scores component determines that the confidence score of response 113 exceeds a predetermined threshold score.

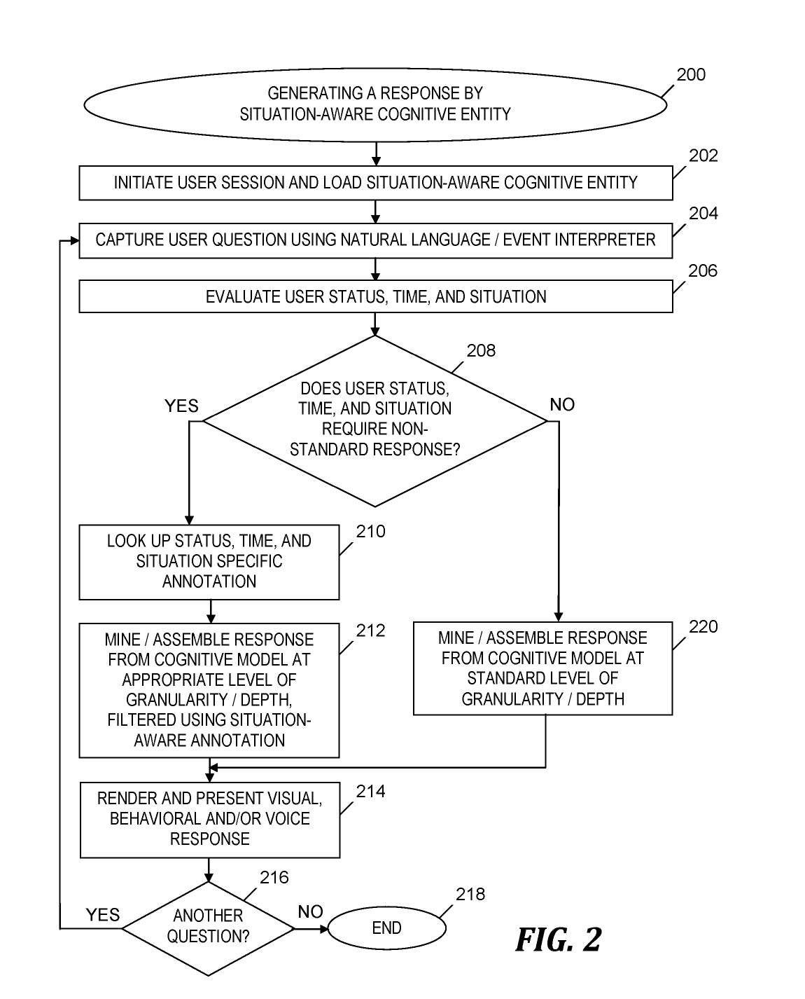

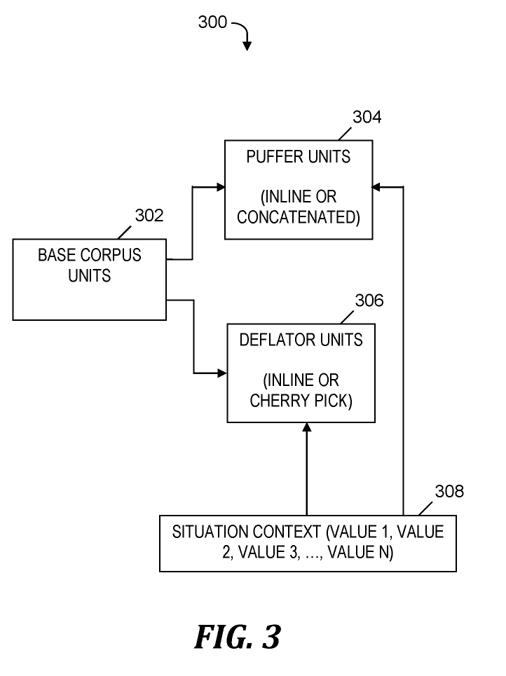

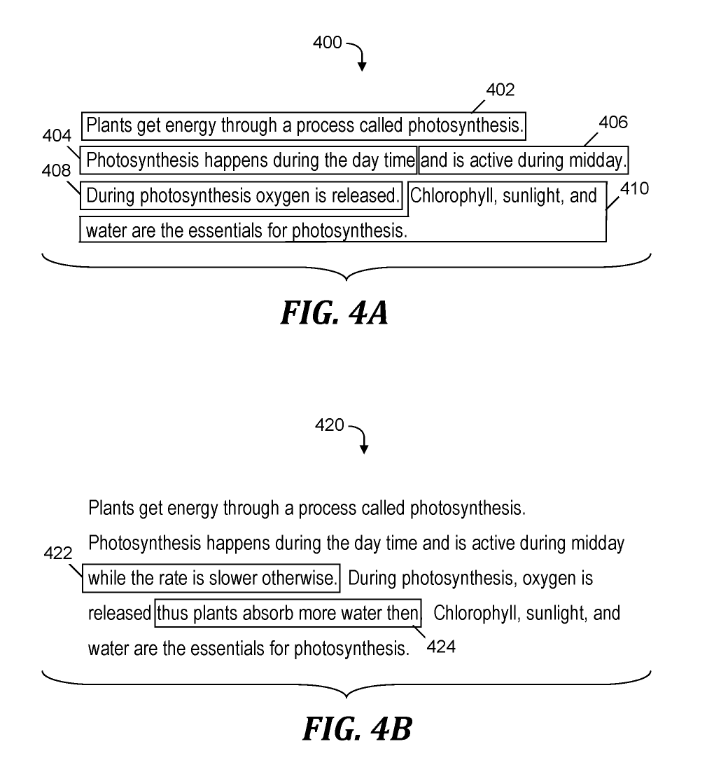

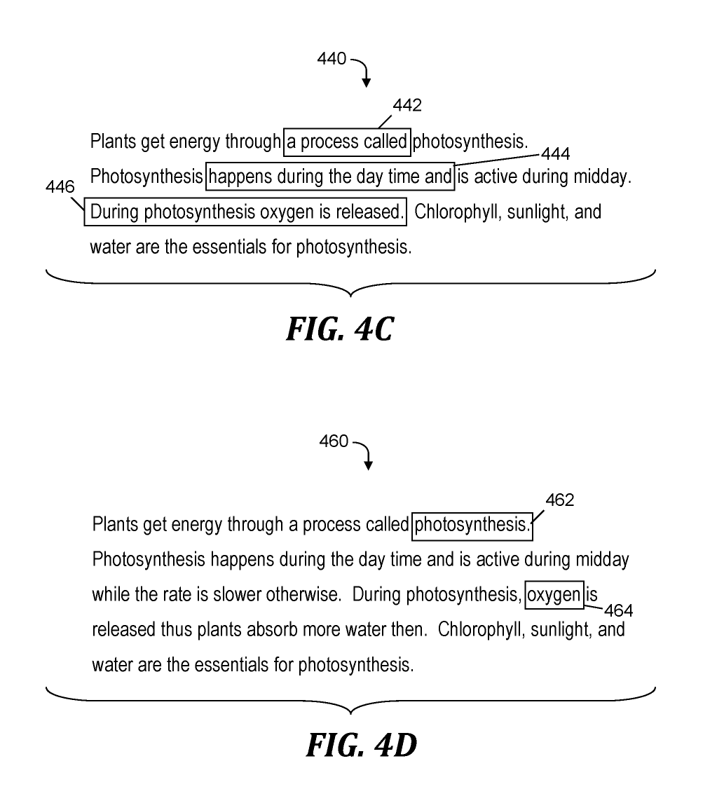

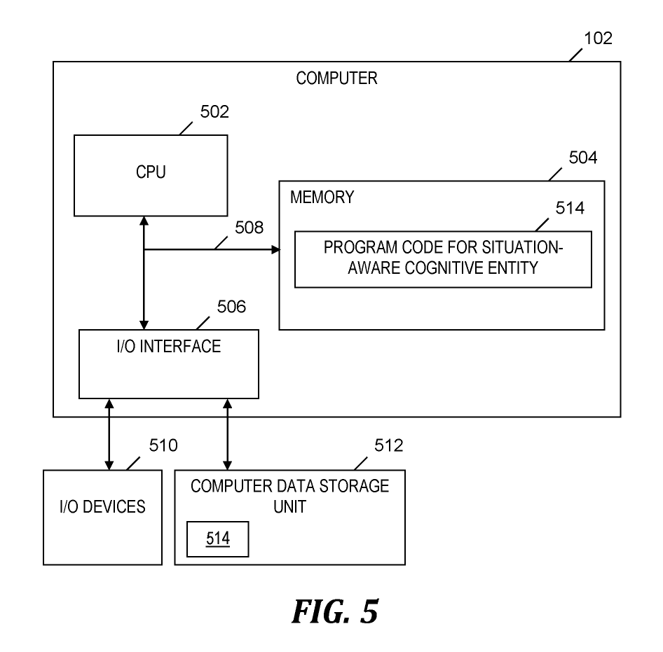

The functionality of the components shown in FIG. 1 is described in more detail in the discussion of FIG. 2, FIG. 3, FIGS. 4A-4D, and FIG. 5 presented below.

### Process for Generating a Response Using an Elastic Cognitive Model

FIG. 2 is a flowchart of a process of generating a response by a cognitive entity using an elastic cognitive model, where the process is implemented by the system of FIG. 1, in accordance with embodiments of the present invention. The process of FIG. 2 starts at step 200. In step 202, computer 102 (see FIG. 1) initiates a user session and loads situation-aware cognitive entity 104 (see FIG. 1).

In step 204, situation-aware cognitive entity 104 (see FIG. 1) captures question 106 (see FIG. 1) from a user using a natural language/event interpreter included in dialog system 108 (see FIG. 1).

In step 206, situation-aware cognitive entity 104 (see FIG. 1) receives and evaluates the context of the user, which includes the status of the user, the current time, and the situation of the user. Alternatively, the process of FIG. 2 includes evaluating other contextual parameters that specify the context of the user. For example, step 206 may include receiving and evaluating profile information of the user, including the user's role in an organization.

In step 208, situation-aware cognitive entity 104 (see FIG. 1) determines whether the status of the user, the current time, and the situation of the user requires a non-standard response. Hereinafter, in the discussion of FIG. 2, the status of the user, the current time, and the situation of the user is referred to as the status, time, and situation. As used herein, a non-standard response is defined as a base response that is modified by puffing up or deflating based on the context of the user. If situation-aware cognitive entity 104 (see FIG. 1) determines in step 208 that the status, time, and situation requires a non-standard response, then the Yes branch of step 208 is taken and step 210 is performed.

In step 210, situation-aware cognitive entity 104 (see FIG. 1) looks up an annotation specific to the status, time, and situation using the situation to annotation mapper 112 (see FIG. 1).

In step 212 and based on the annotation looked up in step 210, situation-based response controller 110 (see FIG. 1) mines or assembles response 113 (see FIG. 1) from a cognitive model, where response 113 (see FIG. 1) is a modification of a base response retrieved from distributed knowledge base 118 (see FIG. 1) and includes a level of granularity and depth (i.e., detail) that is appropriate based on the status, time, and situation (i.e., filtered using situation-aware annotation).

For example, the modification of the base response may include puffing up the base response with additional details for a user whose contextual parameters indicate the user is in a relaxed state and has the time to process a more detailed response, or may include deflating the base response to decrease the amount of detail for a user whose contextual parameters indicate that the user is in an emergency situation or is pressed for time.

In step 214, situation-aware cognitive entity 104 (see FIG. 1) renders and presents response 113 (see FIG. 1) via dialog system 108 (see FIG. 1) as a visual, behavioral, and/or a voice response.

In step 216, situation-aware cognitive entity 104 (see FIG. 1) determines whether there is another question from the user to process. If situation-aware cognitive entity 104 (see FIG. 1) determines in step 216 that there is another question to process, then the Yes branch of step 216 is taken and the process of FIG. 2 loops back to step 204, which begins processing the next question from the user.

If situation-aware cognitive entity 104 (see FIG. 1) determines in step 216 that there is not another question from the user to be processed, then the No branch of step 216 is taken and the process of FIG. 2 ends at step 218.

Returning to step 208, if situation-aware cognitive entity 104 (see FIG. 1) determines that the status, time, and situation does not require a non-standard response, then the No branch of step 208 is taken and step 220 is performed.

In step 220, situation-based response controller 110 (see FIG. 1) mines or assembles response 113 (see FIG. 1) from the cognitive model, where response 113 (see FIG. 1) is a base response at a standard level of granularity and depth. Following step 220, the process of FIG. 2 continues with step 214, as described above.

### Puffer and Deflator Engine Pipelines

FIG. 3 is a block diagram of puffer and deflator engine pipelines 300 used in the process of FIG. 2, in accordance with embodiments of the present invention. In one embodiment, in step 212 (see FIG. 2), situation-aware cognitive entity 104 (see FIG. 1) retrieves base corpus units 302 (i.e., a base response) from distributed knowledge base 118 (see FIG. 1). Base corpus units 302 may be puffed up with puffer units 304 or deflated with deflator units 306 to generate response 113 (see FIG. 1). Base corpus units 302 are puffed up or deflated based on situation context values 308, which specify the context of the user. Puffer units 304 may increase the details of base corpus units 302 by adding details inline in base corpus units 302 or concatenating the additional details to the end of base corpus units 302 to generate response 113 (see FIG. 1). Deflator units 306 may specify inline units which are deleted from base corpus units 302 to generate response 113 (see FIG. 1) or cherry picked units in base corpus units 302, where only the cherry picked units are included in response 113 (see FIG. 1).

### Example

FIG. 4A is an example of a response 400 resulting from the process of FIG. 2 and using an elongated puffer concatenated annotator and a brief puffer concatenated annotator, in accordance with embodiments of the present invention. Response 400 includes a base response 402, along with units 404, 406, 408, and 410 that are concatenated to base response 402. A brief puffer concatenated annotator concatenates unit 404 to base response 402. An elongated puffer concatenated annotator concatenates units 404, 406, 408, and 410 to base response 402. The resulting response 400 is an example of response 113 (see FIG. 1).

FIG. 4B is an example of a response 420 resulting from the process of FIG. 2 and using an elongated puffer inline annotator and a brief puffer inline annotator, in accordance with embodiments of the present invention. Response 420 includes a base response, which is the text in response 420 that does not include unit 422 and unit 424. An elongated puffer inline annotator and a brief puffer inline annotator add unit 422 and unit 424 inline to the base response. The resulting response 420 is an example of response 113 (see FIG. 1).

FIG. 4C is an example of a response 440 that is deflated by the process of FIG. 2, which uses a deflator inline annotator, in accordance with embodiments of the present invention. A deflator inline annotator deflates response 440 by deleting inline units 442, 444, and 446. After the deflation, the resulting response (i.e., the portion of response 440 that does not include units 442, 444, and 446) is an example of response 113 (see FIG. 1).

FIG. 4D is an example of a response 460 that is deflated by the process of FIG. 2, which uses a deflator cherry pick annotator, in accordance with embodiments of the present invention. A deflator cherry pick annotator deflates response 460 by selecting (i.e., cherry picking) units 462 and 464 to be the resulting deflated response in its entirety. The deflated response is an example of response 113 (see FIG. 1).

### Computer System

FIG. 5 is a block diagram of a computer 102 that is included in the system of FIG. 1 and that implements the process of FIG. 2, in accordance with embodiments of the present invention. Computer 102 is a computer system that generally includes a central processing unit (CPU) 502, a memory 504, an input/output (I/O) interface 506, and a bus 508. Further, computer 102 is coupled to I/O devices 510 and a computer data storage unit 512. CPU 502 performs computation and control functions of computer 102, including executing instructions included in program code 514 for situation-aware cognitive entity 104 (see FIG. 1) to perform a method of generating a response by a cognitive entity using an elastic cognitive model, where the instructions are executed by CPU 502 via memory 504. CPU 502 may include a single processing unit, or be distributed across one or more processing units in one or more locations (e.g., on a client and server).

Memory 504 includes a known computer readable storage medium, which is described below. In one embodiment, cache memory elements of memory 504 provide temporary storage of at least some program code (e.g., program code 514) in order to reduce the number of times code must be retrieved from bulk storage while instructions of the program code are executed. Moreover, similar to CPU 502, memory 504 may reside at a single physical location, including one or more types of data storage, or be distributed across a plurality of physical systems in various forms. Further, memory 504 can include data distributed across, for example, a local area network (LAN) or a wide area network (WAN).

I/O interface 506 includes any system for exchanging information to or from an external source. I/O devices 510 include any known type of external device, including a display, keyboard, etc. Bus 508 provides a communication link between each of the components in computer 102, and may include any type of transmission link, including electrical, optical, wireless, etc.

I/O interface 506 also allows computer 102 to store information (e.g., data or program instructions such as program code 514) on and retrieve the information from computer data storage unit 512 or another computer data storage unit (not shown). Computer data storage unit 512 includes a known computer-readable storage medium, which is described below. In one embodiment, computer data storage unit 512 is a non-volatile data storage device, such as a magnetic disk drive (i.e., hard disk drive) or an optical disc drive (e.g., a CD-ROM drive which receives a CD-ROM disk).

Memory 504 and/or storage unit 512 may store computer program code 514 that includes instructions that are executed by CPU 502 via memory 504 to generate a response by a cognitive entity using an elastic cognitive model. Although FIG. 5 depicts memory 504 as including program code, the present invention contemplates embodiments in which memory 504 does not include all of code 514 simultaneously, but instead at one time includes only a portion of code 514.

Further, memory 504 may include an operating system (not shown) and may include other systems not shown in FIG. 5.

Storage unit 512 and/or one or more other computer data storage units (not shown) may include distributed knowledge base 118 (see FIG. 1) and the contextual parameters that specify the context of the user.

As will be appreciated by one skilled in the art, in a first embodiment, the present invention may be a method; in a second embodiment, the present invention may be a system; and in a third embodiment, the present invention may be a computer program product.

Any of the components of an embodiment of the present invention can be deployed, managed, serviced, etc. by a service provider that offers to deploy or integrate computing infrastructure with respect to generating a response by a cognitive entity using an elastic cognitive model. Thus, an embodiment of the present invention discloses a process for supporting computer infrastructure, where the process includes providing at least one support service for at least one of integrating, hosting, maintaining and deploying computer-readable code (e.g., program code 514) in a computer system (e.g., computer 102) including one or more processors (e.g., CPU 502), wherein the processor(s) carry out instructions contained in the code causing the computer system to generate a response by a cognitive entity using an elastic cognitive model. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of generating a response by a cognitive entity using an elastic cognitive model.

While it is understood that program code 514 for generating a response by a cognitive entity using an elastic cognitive model may be deployed by manually loading directly in client, server and proxy computers (not shown) via loading a computer-readable storage medium (e.g., computer data storage unit 512), program code 514 may also be automatically or semi-automatically deployed into computer 102 by sending program code 514 to a central server or a group of central servers. Program code 514 is then downloaded into client computers (e.g., computer 102) that will execute program code 514. Alternatively, program code 514 is sent directly to the client computer via e-mail. Program code 514 is then either detached to a directory on the client computer or loaded into a directory on the client computer by a button on the e-mail that executes a program that detaches program code 514 into a directory. Another alternative is to send program code 514 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 514 is transmitted to the proxy server and then it is stored on the proxy server.

Another embodiment of the invention provides a method that performs the process steps on a subscription, advertising and/or fee basis. That is, a service provider can offer to create, maintain, support, etc. a process of generating a response by a cognitive entity using an elastic cognitive model. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product at any possible technical detail level of integration. The computer program product may include a computer readable storage medium (or media) (i.e., memory 504 and computer data storage unit 512) having computer readable program instructions 514 thereon for causing a processor (e.g., CPU 502) to carry out aspects of the present invention.

The computer readable storage medium can be a tangible device that can retain and store instructions (e.g., program code 514) for use by an instruction execution device (e.g., computer 102). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 514) described herein can be downloaded to respective computing/processing devices (e.g., computer 102) from a computer readable storage medium or to an external computer or external storage device (e.g., computer data storage unit 512) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 514) for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIG. 2) and/or block diagrams (e.g., FIG. 1, FIG. 3, and FIG. 5) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 514).

These computer readable program instructions may be provided to a processor (e.g., CPU 502) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 512) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 514) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of generating a response by a cognitive entity, the method comprising the steps of:
a computer receiving a question input by a user to the cognitive entity;
the computer determining a context of the user;
based on the context of the user, the computer selecting an amount of detail for the response to the question, the amount of detail being selected from different amounts of detail; and
the computer generating and presenting the response to the user so that the response has the selected amount of detail.

2. The method of claim 1, further comprising the step of the computer determining a role of the user in an organization, wherein the step of selecting the amount of detail is based on the role of the user in the organization.

3. The method of claim 1, further comprising the steps of:
the computer receiving audio data about an area surrounding the user; and
based on the audio data, the computer determining that the user is in an emergency situation, wherein the step of selecting the amount of detail is based on the user being in the emergency situation and includes selecting one of the different amounts of detail that is less than a predetermined threshold amount of detail.

4. The method of claim 1, wherein the method further comprises the step of the computer determining a social position of the user, wherein the step of selecting the amount of detail is based on the social position of the user.

5. The method of claim 1, further comprising the steps of:
the computer receiving in real time biometric data about the user; and
based on the received biometric data, the computer determining that the user is in a relaxed mood, wherein the step of selecting the amount of detail is based on the user being in the relaxed mood and includes selecting one of the different amounts of detail that is greater than a predetermined threshold amount of detail.

6. The method of claim 1, further comprising the step of based on the context of the user, the computer selecting an inline annotator, a concatenated annotator, or a deflator, wherein the step of generating the response is based on the selected inline annotator, concatenated annotator, or deflator.

7. The method of claim 1, further comprising the steps of:
the computer continuously receiving data about the user to refine the context of the user over a period of time, the refined context including a first context of the user at a first time within the period of time and a second context of the user at a second time within the period of time, the second time being subsequent to the first time;
based on the first context and prior to the second time, the computer selecting a first amount of detail for a first response to the question;
based on the first context and prior to the second time, the computer generating and presenting the first response so that the first response has the first amount of detail;
based on the second context, the computer selecting a second amount of detail for a second response to the question, the second amount of detail being different from the first amount of detail; and
based on the second context, the computer generating and presenting the second response so that the second response has the second amount of detail.

8. The method of claim 1, further comprising the step of:
providing at least one support service for at least one of creating, integrating, hosting, maintaining, and deploying computer readable program code in the computer, the program code being executed by a processor of the computer to implement the steps of receiving the question, determining the context of the user, selecting the amount of detail for the response, and generating and presenting the response to the user so that the response has the selected amount of detail.

9. A computer program product for generating a response by a cognitive entity, the computer program product comprising a computer readable storage medium having program instructions stored in the computer readable storage medium, wherein the computer readable storage medium is not a transitory signal per se, the program instructions are executed by a central processing unit (CPU) of a computer system to cause the computer system to perform a method comprising the steps of:
the computer system receiving a question input by a user to the cognitive entity;
the computer system determining a context of the user;
based on the context of the user, the computer system selecting an amount of detail for the response to the question, the amount of detail being selected from different amounts of detail; and
the computer system generating and presenting the response to the user so that the response has the selected amount of detail.

10. The computer program product of claim 9, wherein the method further comprises the step of the computer system determining a role of the user in an organization, wherein the step of selecting the amount of detail is based on the role of the user in the organization.

11. The computer program product of claim 9, wherein the method further comprises the steps of:
the computer system receiving audio data about an area surrounding the user; and
based on the audio data, the computer system determining that the user is in an emergency situation, wherein the step of selecting the amount of detail is based on the user being in the emergency situation and includes selecting one of the different amounts of detail that is less than a predetermined threshold amount of detail.

12. The computer program product of claim 9, wherein the method further comprises the step of the computer system determining a social position of the user, wherein the step of selecting the amount of detail is based on the social position of the user.

13. The computer program product of claim 9, wherein the method further comprises the steps of:
the computer system receiving in real time biometric data about the user; and
based on the received biometric data, the computer system determining that the user is in a relaxed mood, wherein the step of selecting the amount of detail is based on the user being in the relaxed mood and includes selecting one of the different amounts of detail that is greater than a predetermined threshold amount of detail.

14. The computer program product of claim 9, wherein the method further comprises the step of based on the context of the user, the computer system selecting an inline annotator, a concatenated annotator, or a deflator, wherein the step of generating the response is based on the selected inline annotator, concatenated annotator, or deflator.

15. A computer system comprising:
a central processing unit (CPU);
a memory coupled to the CPU; and
a computer readable storage medium coupled to the CPU, the computer readable storage medium containing instructions that are executed by the CPU via the memory to implement a method of generating a response by a cognitive entity, the method comprising the steps of:
the computer system receiving a question input by a user to the cognitive entity;
the computer system determining a context of the user;
based on the context of the user, the computer system selecting an amount of detail for the response to the question, the amount of detail being selected from different amounts of detail; and
the computer system generating and presenting the response to the user so that the response has the selected amount of detail.

16. The computer system of claim 15, wherein the method further comprises the step of the computer system determining a role of the user in an organization, wherein the step of selecting the amount of detail is based on the role of the user in the organization.

17. The computer system of claim 15, wherein the method further comprises the steps of:
the computer system receiving audio data about an area surrounding the user; and
based on the audio data, the computer system determining that the user is in an emergency situation, wherein the step of selecting the amount of detail is based on the user being in the emergency situation and includes selecting one of the different amounts of detail that is less than a predetermined threshold amount of detail.

18. The computer system of claim 15, wherein the method further comprises the step of the computer system determining a social position of the user, wherein the step of selecting the amount of detail is based on the social position of the user.

19. The computer system of claim 15, wherein the method further comprises the steps of:
the computer system receiving in real time biometric data about the user; and
based on the received biometric data, the computer system determining that the user is in a relaxed mood, wherein the step of selecting the amount of detail is based on the user being in the relaxed mood and includes selecting one of the different amounts of detail that is greater than a predetermined threshold amount of detail.

20. The computer system of claim 15, wherein the method further comprises the step of based on the context of the user, the computer system selecting an inline annotator, a concatenated annotator, or a deflator, wherein the step of generating the response is based on the selected inline annotator, concatenated annotator, or deflator.
